(19) United States
(12) Patent Application Publication
(10) Pub. No.: US 2007/0263348 A1
(43) Pub. Date: Nov. 15, 2007

(54) Versatile portable electronic device docking station with slidable connector

(75) Inventors: Mark Rutledge, Murrieta, CA (US); John Durbin, San Diego, CA (US); Harry Fu, San Marcos, CA (US); David Hatcher, Wildomar, CA (US); Michelle Lin, Murrieta, CA (US)

Correspondence Address: Directed Electronics, Inc., One Viper Way, Vista, CA, 92081, US

(73) Assignee: DEI Headquarters Inc.

(21) Appl. No.: 11/641,538

(22) Filed: Dec. 19, 2006

Related U.S. Application Data
(63) Continuation-in-part of application No. 11/265,331, filed on Nov. 2, 2005.

(51) Int. Cl. G06F 1/16

(52) U.S. Cl. 361/681

(57) ABSTRACT

A docking station provides supporting functions for portable electronic devices, such as music players, satellite radio receivers, and video game players. The supporting functions may include providing power, an audio amplifier, speakers, and a video or audio display. The docking station includes a base portion and a connector slidably engaged with the base portion for centering the portable electronic device with respect to the base portion. The base portion includes circuitry for processing signals from the portable electronic device. The connector can be attached to a circuit board that is slidably disposed between the base portion and an attachment portion removably connected to the base portion. The docking station can recognize the type of device connected and configure itself to accommodate the requirements of the portable electronic device. The docking station can include a display portion perpendicular to the base portion.

### PRIORITY

This application claims priority to U.S. patent application Ser. No. 11/265,331, filed on Nov. 2, 2005, entitled “Versatile Docking Station for Portable Electronic Devices”, the contents of which are fully incorporated by reference herein.

### FIELD OF THE INVENTION

The embodiments of the present invention relate generally to docking stations, and more particularly, to docking stations for portable electronic devices.

### BACKGROUND

Portable entertainment devices, such as audio and video players, have become popular in recent years. Portable players may use MP3, RealAudio, MJPEG, MPEG, and other audio and video compression formats. Moreover, as the cost, size, and power consumption of non-volatile memory devices decrease, use of uncompressed files in players may become more feasible. Both audio and video players may also use storage media such as compact discs (CDs) and digital video discs (DVDs). Portable radio devices are also popular among consumers. These portable radios include conventional radios with amplitude modulation (AM) and frequency modulation (FM) receiver bands, as have been know for many years, along with satellite radio devices, such as those offered by Sirius® Satellite Radio Inc. and XM® Satellite Radio Inc. There are a variety of other portable electronic devices that can be used for entertainment, communications or other informational exchange, including, without limitation, television sets, dedicated game devices, game consoles, cellular telephones, portable digital assistants (PDAs), and voice recorders/players.

In part due to the popularity of portable audio and video devices, companies have started to produce “docking stations” for portable electronic devices to supplement the capabilities of the portable devices. A docking station allows its user to enjoy “non-portable” performance from a portable device. This is the case, for example, with the iPod® music players, which can be plugged into a docking station. Docking stations are typically designed for compatibility with a single product or with a line of products of a single manufacturer. Consequently, a user may be required to purchase, and manufacturers may be required to develop, manufacture, and inventory multiple docking stations for use with portable devices of different manufacturers, or even for use with different product lines of the same manufacturer. This approach is inconvenient, expensive, and leads to inefficient use of space and manufacturers' resources. Therefore, it is desirable to provide a docking station that can be used with portable devices from various manufacturers.

One drawback of conventional docking stations however, is the lack of mobility of the connector on the docking station, which connects to the connector on the portable device to removably secure the portable device to the docking station. While some portable devices employ a connector located at the same location as other portable devices, other portable devices have a connector located at a different location. Because of this difference in the location of the connector portion on the portable device, the alignment of the portable device on the docking station will vary depending on the location of the connector on the portable device. While the resulting variation may be unnoticeable with some devices, the variation due to other devices may be significantly recognizable depending on the size of the portable device in relation to the docking station. With docking stations that are designed to center the portable device in relation to the docking station, or a display attached to the docking station, a significant misalignment of the portable device and the docking station can have a substantial negative effect on the desirability of the docking station with consumers.

Therefore, it would be advantageous to provide a docking station for portable electronic devices that allows for connection of various audio and video devices having connectors located in various regions of the device, as well as allows the portable device to be centrally located with respect to the docking station, and any displays connected thereto, once the device is attached to the docking station.

### SUMMARY

The preferred embodiment of the invention is directed to a docking station comprising a base portion having circuitry therein for processing signals from at least one portable electronic device connected to the base portion, and a connector slidably engaged with the base portion for connecting a portable electronic device to the base portion. The connector includes a first pin configuration for communicating with portable electronic devices of a first type. A user can removably secure the at least one portable electronic device to the connector to allow electrical communication between the docking station and the portable electronic device, and can connect the portable electronic device to the base portion such that the portable electronic device is centrally located with respect to the base portion. In another embodiment, the docking station can include a display portion connected to the base portion, the display portion being substantially perpendicular with the base portion. The connector allows a user to connect the portable electronic device to the base portion such that the portable electronic device is centrally located with respect to the display portion.

In another embodiment, the docking station also includes a cradle removably attached to the base portion. The cradle has an opening therein wherein the connector is disposed therethrough. The opening is configured to cause the connector to translate along an axis with respect to the base portion to alter the location of the portable electronic device with respect to the base portion, and if present, the display portion. In another embodiment, the connector is coupled to a circuit board, the circuit board being disposed between the base portion and the cradle such that the circuit board is slidably engaged with respect to the base portion. The circuit board is removably secured to the cradle by a screw or other attachment means.

In another embodiment, the docking station can also include a stationary connector coupled to the base portion. The stationary connector includes a second pin configuration for communicating with portable electronic devices of a second type. The docking station can also include a device recognizer configured to recognize the type of portable electronic device connected to the docking station through the connector and the stationary connector, and provide a signal to the portable electronic device corresponding to the determined type of portable electronic device. The device recognizer can be configured to recognize a plurality of portable electronic devices such as satellite radio enabled portable electronic devices, music player portable electronic devices, game console portable electronic devices, and video player portable electronic devices.

In another embodiment, the docking station includes a configurable power supply module capable of providing power to the at least one portable electronic device through the connector. The power supply module is configured responsive to the determined type of portable electronic device. In another embodiment, the docking station includes an audio amplifier configured to receive an audio signal from a portable electronic device through the connector, wherein the audio amplifier is configured responsive to the determined type of portable electronic device. In this embodiment, the display portion comprises an audio display having at least one speaker. The docking station can also include a digital rights management module configured selectively to enable playback of the audio signal depending on availability at the docking station of rights to content represented by the audio signal. In another embodiment, the docking station can also include an audio amplifier configured to receive an audio signal from portable electronic devices through the connector, wherein input impedance of the audio amplifier is configured responsive to the determined type of portable electronic device.

In another embodiment, the display portion includes a video display, wherein the connector comprises video input for driving the video display with one or more video signals. The video display can span the entire display portion or can encompass only a portion of the display portion. The docking station can also include a digital rights management module configured selectively to enable playback of the one or more video signals depending on the availability at the docking station of rights to content represented by the audio signal. In another embodiment, the docking station includes circuitry for allowing the docking station to be wirelessly controlled via a remote control. The docking station can also be equipped to wirelessly interact with external speakers.

These and other features and aspects of the embodiments of the invention will be better understood with reference to the description, drawings, and appended claims.

### BRIEF DESCIRPTION OF THE FIGURES

FIG. 1 shows a front perspective view of the versatile portable electronic device docking station with slidable connector, showing the portable device cradle detached from the base portion.

FIG. 2 shows a front perspective view of an embodiment of the versatile portable electronic device docking station with slidable connector, showing the portable device cradle attached to the base portion.

FIG. 3 shows a detailed view of the connector portion of the docking station with the cradle detached from the base portion and the slidable connector in a first position contacting the right edge of the slidable connector opening.

FIG. 4 shows a detailed view of the connector portion of the docking station with the cradle detached from the base portion and the slidable connector in a second position contacting the left edge of the slidable connector opening.

FIG. 5 shows a detailed view of the connector portion of the docking station with one embodiment of the cradle attached to the base portion and the slidable connector in a second position contacting the left edge of the slidable connector opening.

FIG. 6 shows a detailed view of the connector portion of the docking station with another embodiment of the cradle attached to the base portion, the slidable connector in a second position contacting the left edge of the slidable connector opening.

FIG. 7 shows a front perspective view of the docking station with a portable electronic device removably attached thereto, the portable electronic device being centrally located with respect to the base portion.

FIG. 8 shows a front view of the docking station with a portable electronic device removably attached thereto, the portable electronic device being centrally located with respect to the base portion.

FIG. 9 shows a detailed front perspective view of the base portion of the docking station with the top housing removed, with the cradle housing detached therefrom.

FIG. 10 shows a front view of another embodiment of the versatile portable electronic device docking station with slidable connector.

FIG. 11 shows a front view of another embodiment of the versatile portable electronic device docking station with slidable connector, with one type of portable electronic device attached thereto.

FIG. 12 shows a front view of another embodiment of the versatile portable electronic device docking station with slidable connector, with another type of portable electronic device attached thereto.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts. The drawings are in a simplified form and are not to precise scale. For purposes of convenience and clarity only, directional terms, such as, top, bottom, left, right, up, down, over, above, below, beneath, rear, and front, may be used with respect to the accompanying drawings. These and similar directional terms should not be construed to limit the scope of the invention in any manner. Furthermore, in descriptions and in claims, “couple,” “connect,” and similar words with their inflectional morphemes do not necessarily import an immediate or direct connection, but include connections through mediate elements within their meanings.

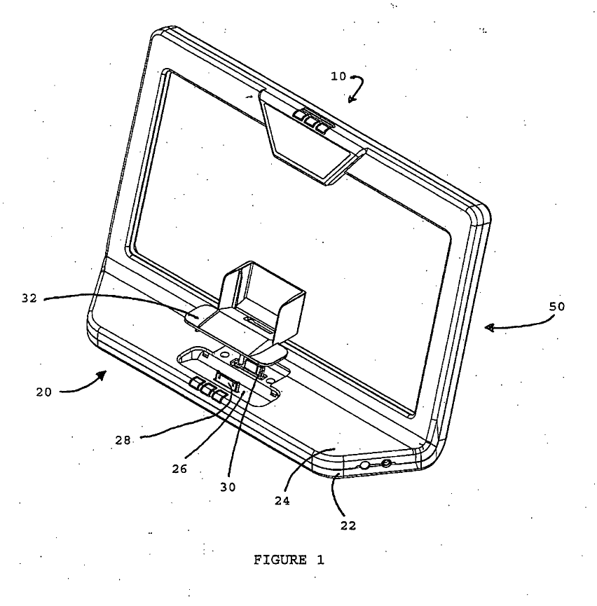

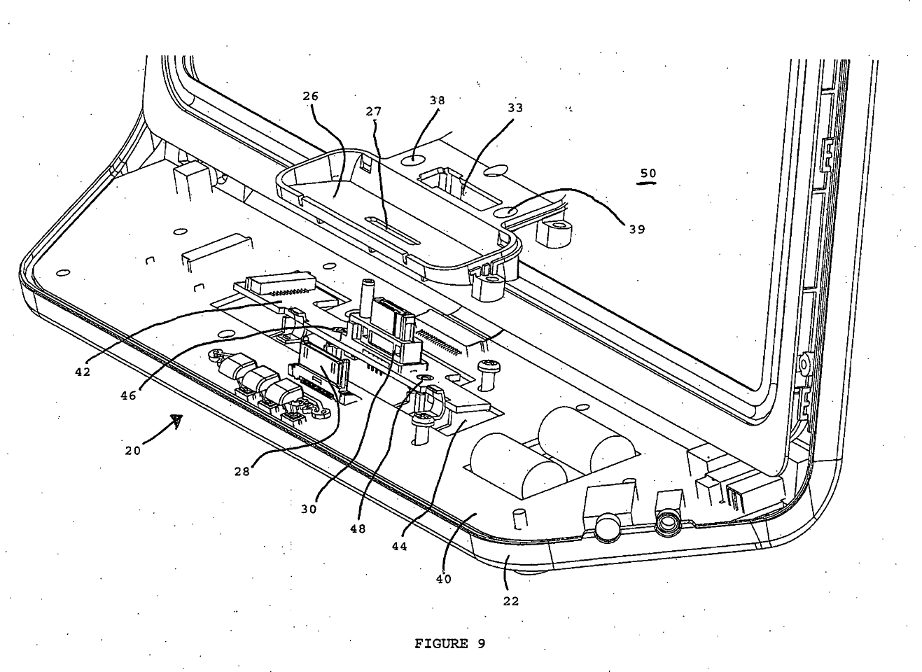

Referring more particularly to the drawings, FIG. 1 shows a front perspective view of an embodiment of the versatile portable electronic device docking station with slidable connector 10. Docking station 10 includes a base portion 20 and a display portion 50. Base portion 20 includes a lower housing 22, an upper housing 24, and a cradle housing 26. Lower housing 22 and upper housing 24 contain circuitry 23 therein (see FIG. 9) for processing various signals from at least one portable electronic device and providing corresponding output. Cradle housing 26 includes an opening 27 (see FIG. 9) wherein a fixed connector 28 is disposed therethrough, and an opening 33 (see FIG. 9) wherein a slidable connector 30 is disposed therethrough. Fixed connector 28 and slidable connector 30 are preferably configured to communicate with portable electronic devices having connectors with different pin configurations. However, it is to be recognized that fixed connector 28 and slidable connector 30 can comprise connectors having similar pin configurations. Fixed connector 28 and slidable connector 30 can have various pin configurations to interface with various types of connectors for various types of portable electronic devices as would be recognized by one with ordinary skill in the art.

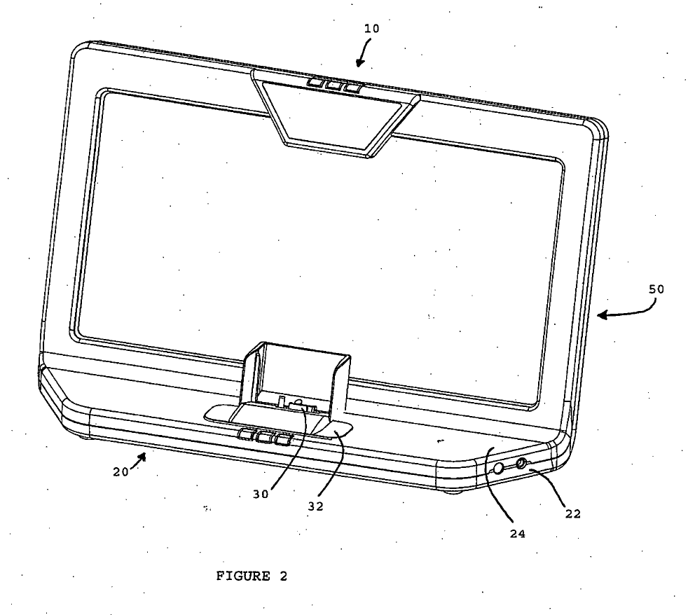

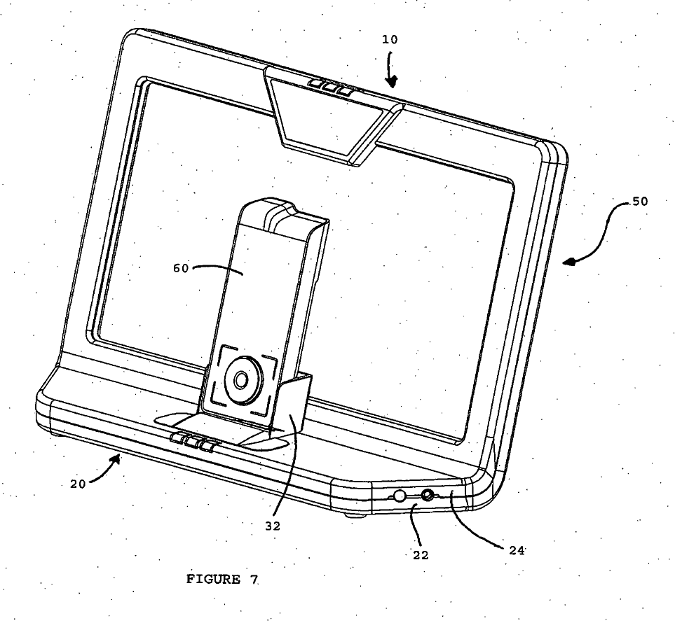

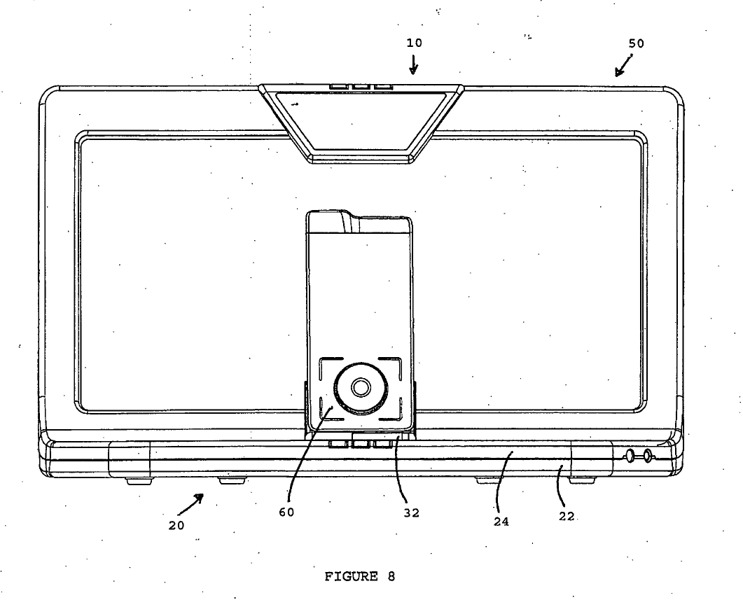

A cradle 32 is designed to fit within cradle housing 26 and to cover either fixed connector 28 or slidable connector 30. Cradle 32 is preferably designed to snap into cradle housing 26. However, cradle 32 can also be designed to be secured to cradle housing 26 by a screw or other attachment means. In this figure, cradle 32 is detached from cradle housing 26. Referring now to FIG. 2, FIG. 2 shows a front perspective view of docking station 10 with cradle 32 secured to cradle housing 26 (not shown). Cradle 32 is designed to cover fixed connector 28 and make slidable connector 30 available. A portable electronic device 60 (see FIGS. 7 and 8) can be removably positioned within cradle 32 and connected to slidable connector 30 to allow electrical communication between docking station 10 and portable electronic device 60. Cradle 32 can comprise various designs to accommodate the different sizes and shapes of various portable electronic devices. Cradle 32 is preferably comprised of a polymer based material, but can be comprised of various other materials as recognized in the art.

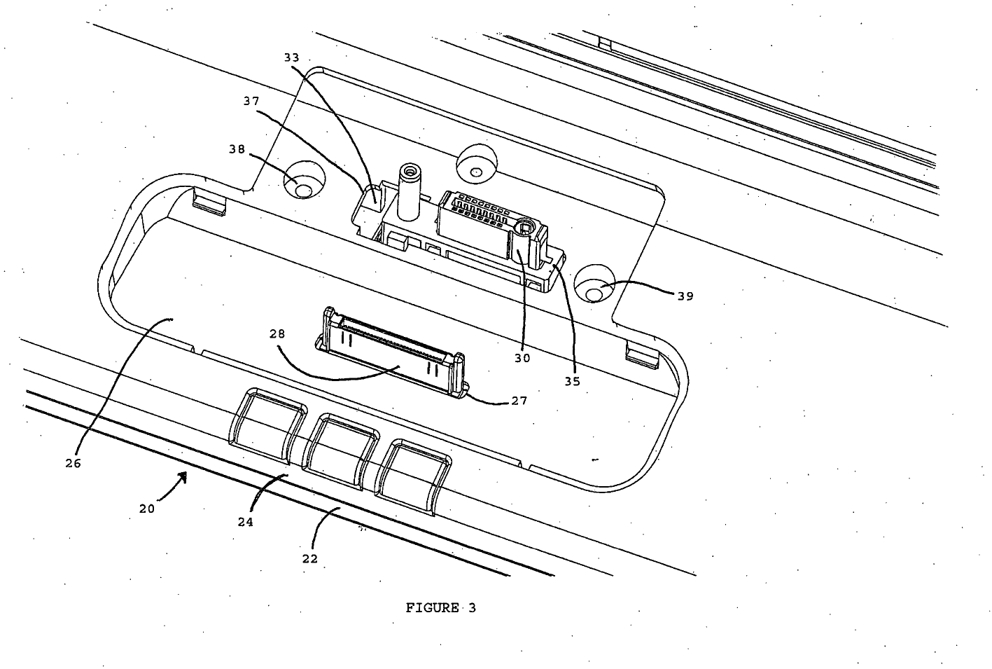

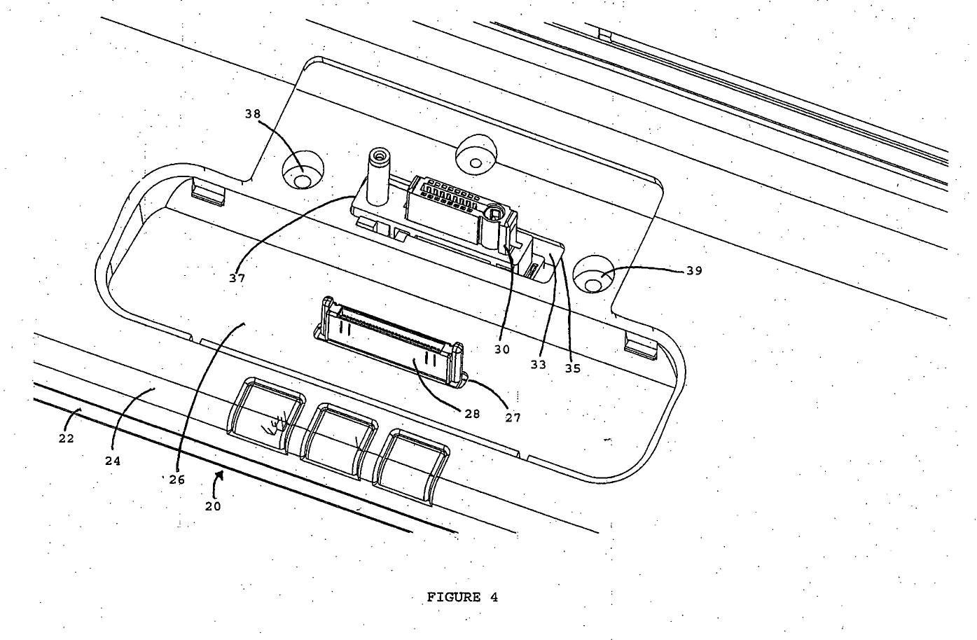

FIGS. 3 and 4 show a detailed view of the central portion of base portion 20, with cradle 32 detached from cradle housing 26. In FIG. 3, slidable connector 30 is in a first position contacting the right edge 35 of a slidable connector opening 33. In FIG. 4, slidable connector 30 is in a second position contacting the left edge 37 of the slidable connector opening 33. The position of slidable connector 30 will vary depending on the particular cradle 32 attached to base portion 20. For example, a cradle 32 with one particular portable electronic device 60 located therein, may position device 60 such that the connector portion on device 60 (not shown) requires slidable connector 30 to be in the first position contacting right edge 35. A user can secure slidable connector 30 in the first position (contacting right edge 35) by inserting a screw (not shown) into screw hole 39. A user can secure slidable connector 30 in the second position (contacting left edge 37) by inserting a screw (not shown) into screw hole 38.

Slidable connector opening 33 is preferably dimensioned to allow slidable connector 30 to translate along one axis with respect to display portion 50, namely horizontally (i.e. movement along an X-axis). However, slidable connector opening 33 can be dimensioned to allow slidable connector 30 to translate along more than one axis with respect to display portion 50, such as a depth translation (movement along a Y-axis). In other embodiments, slidable connector opening 33 can be dimensioned to allow slidable connector 30 to translate vertical vertically with respect to base portion 20 (movement along a Z-axis). Slidable connector opening 33 can vary in size and dimension depending on the size of slidable connector 30 and the range of movement desired in relation to display portion 50.

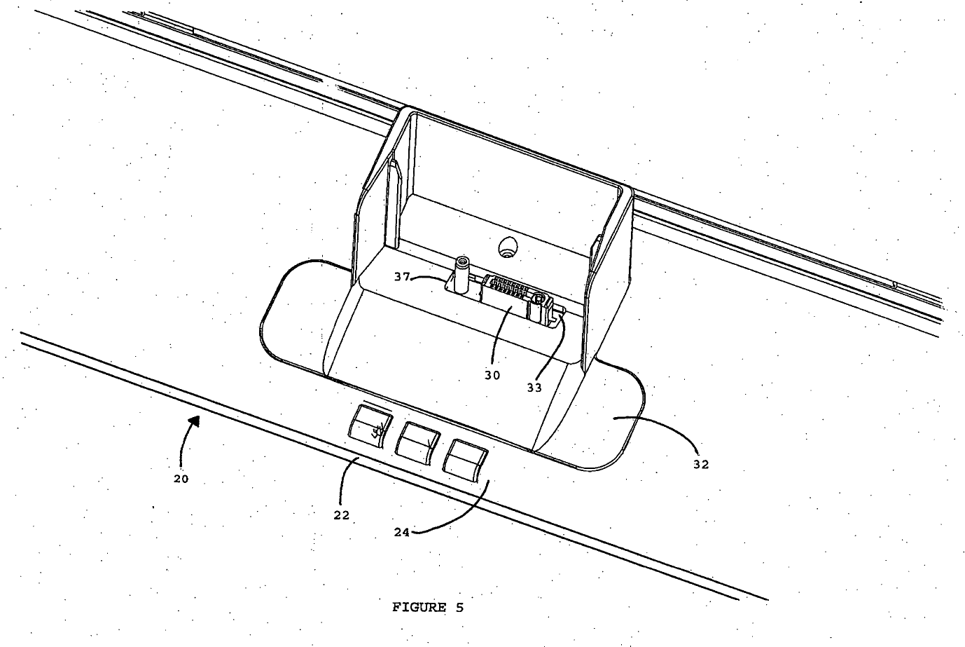

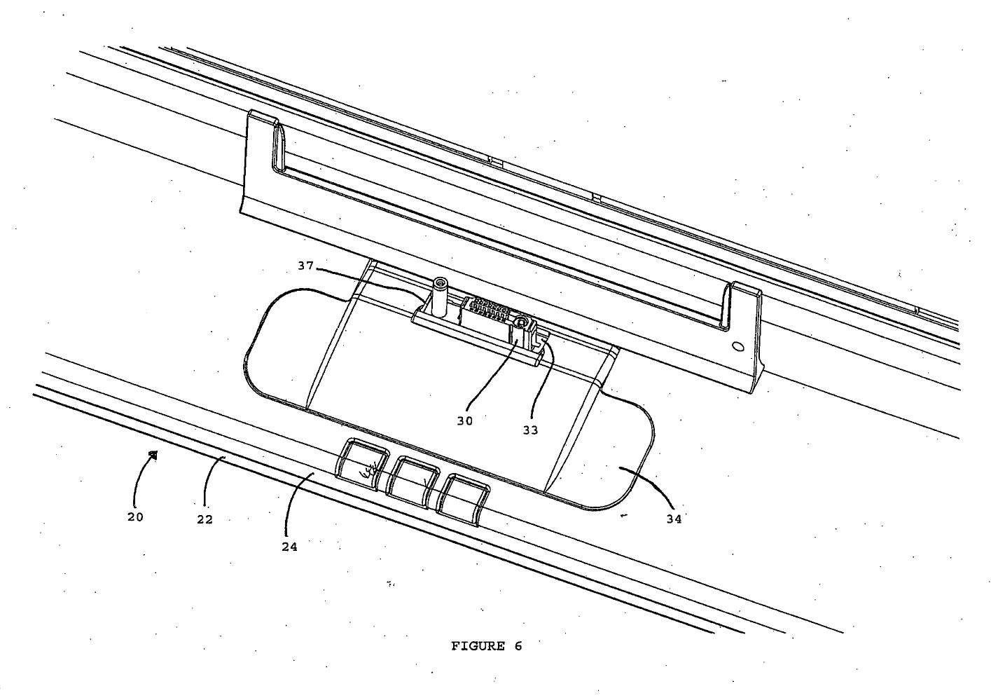

FIGS. 5 and 6 show detailed views of connector region 26 with a cradle attached to base portion 20. In these views, slidable connector 30 is in a second position contacting left edge 37. FIG. 5 shows one embodiment of a cradle 32 for use with a portable electronic device having a narrow base, such as that seen in FIGS. 7 and 8. FIG. 6 shows another embodiment of a cradle 34 for use with a different portable electronic device having a wider base region. The cradles 32 and 34 shown in no way encompass all of the variations that may exist in cradle design, as many other shaped and sized cradles may be attached to base portion 20 and still remain within the scope of this invention. Further, although as shown cradles 32 and 34 are connected to the base portion 20, in other embodiments cradles 32 and 34 may be secured to any portion of display portion 50, preferably the lower region.

Referring now to FIGS. 7 and 8, FIG. 7 illustrates a front perspective view and FIG. 8 illustrates a front view of docking station 10 with a portable electronic device 60 removably attached thereto. In these figures, portable electronic device 60 is centrally located with respect to display portion 50 and base portion 20, regardless of the location of the connector portion on portable electronic device 60. For example, if the connector portion on portable electronic device 60 was located near right edge 35 (FIGS. 3 and 4), the cradle 32 used for that portable electronic device 60 would cause slidable connector 30 to be positioned to contact right edge 35 such that when portable electronic device 60 was placed on slidable connector 30, portable electronic device would be centrally located with respect to both display portion 50 and base portion 20.

FIG. 9 shows a detailed front perspective view of base portion 20 of docking station 10 with the top housing 24 removed, exposing circuit board 40, with cradle housing 26 detached from base portion 20. Circuit board 40 contains circuitry for the various functions and features of docking station 10, including power supply, device detection and recognition functions, digital rights management circuitry, and audio and video signal processing. Such circuitry can comprise traditional components for such purposes as would be recognized by one with ordinary skill in the art. Circuit board 40 can also include circuitry for processing wireless signals from a remote control (not shown), to allow a user to operate docking station 10 via a remote control. Docking station 10 is preferably configured to receive infrared signals, but may also receive radio signals, Bluetooth signals, or other wireless communication signal. Additionally, circuit board 40 can contain transmitting circuitry for wirelessly sending signals to one or more external speakers (not shown) located at a particular distance from docking station 10, which can range from within several feet to throughout an entire house or small office space. Circuit board 40 has a fixed position within base portion 20 by being screwed or otherwise fastened to lower housing 22. Cradle housing 26 is designed to fit over fixed connector 28 and slidable connector 30. Cradle housing 26 serves to provide an attachment point to cradle 32, cradle 34, or any other cradle embodiments. Cradle housing 26 can be attached to base portion 20 by screws or other fastening device.

Slidable connector 30 is fixedly secured to movable circuit board 42. Movable circuit board 42 is designed to fit within the opening 44 formed by circuit board 40. Movable circuit board 42 can translate freely with respect to base portion 20, thus allowing slidable connector 30 to translate accordingly. The ability of movable circuit board 42 to translate is restricted by opening 33 and/or opening 44. Generally however, opening 33 and opening 44 will be sized such that the movement of movable circuit board 42 will be equally restricted by openings 33 and 44. To prevent movement of movable circuit board 42, a user can place a screw (not shown) through either screw holes 38 and 39, which match up with screw holes 46 and 48 respectively in movable circuit board 42, to secure movable circuit board 42 to cradle housing 26. Because cradle housing 26 is fixedly secured to base portion 20, the screws prevent movable circuit board 42 from translating with respect to either base portion 20 or display portion 50.

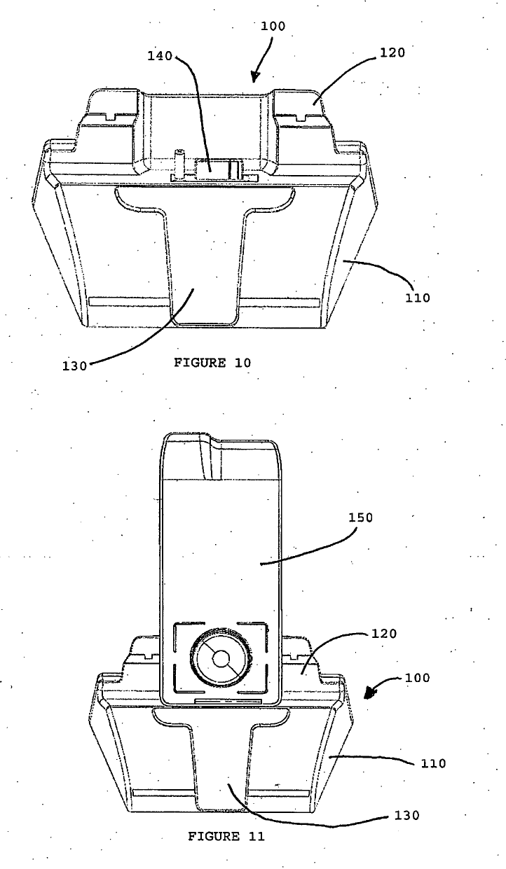

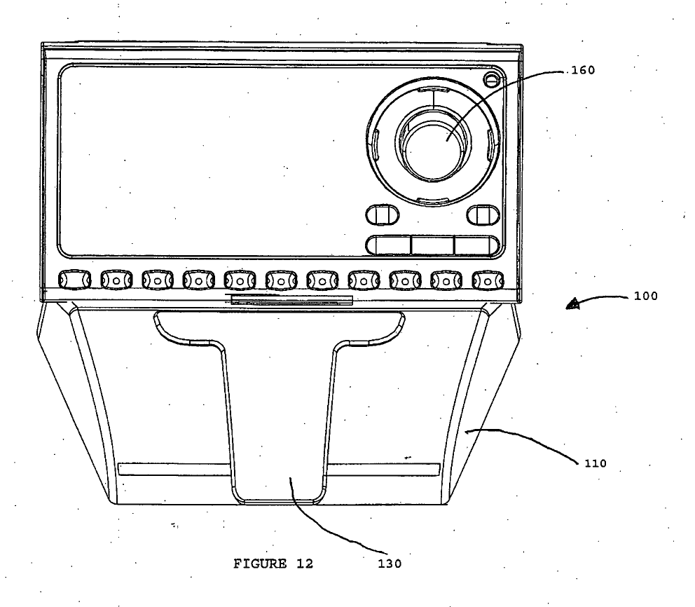

Referring now to FIGS. 10-12, there is shown another embodiment of the versatile portable electronic device docking station with slidable connector 100. Docking station 100 includes a base portion 110, a support portion 120, a cradle region 130, and a slidable connector 140. Base portion 110 can contain similar circuitry and circuit boards as base portion 20 of docking station 10, such circuitry performing similar functions such as device recognition and configuring of docking station 100 to suit the particular type of device attached thereto. Further, slidable connector 140 is similarly engaged with base portion 110 as slidable connector 30 in docking station 10, namely attached to a movable circuit board located within base portion 110. This allows portable electronic devices, such as devices 150 and 160, to be centralized with respect to base portion 110. Support portion 120 serves to stabilize the portable electronic devices 150 and 160 that can be secured to base portion 110 via connector 140. Similar to docking station 10, docking station 100 can be shaped to fit various types of portable electronic devices and can be comprised of various different materials as would be recognized in the art.

This document describes the inventive devices for the connection of portable electronic devices to a docking station. This is done for illustration purposes only. Neither the specific embodiments of the invention as a whole, nor those of its features limit the general principles underlying the invention. The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is served by the claims and their equivalents.

I claim:

1. A docking station comprising:
a) a base portion having circuitry therein for processing signals from at least one portable electronic device connected to the base portion; and
b) at least one connector slidably engaged with the base portion for connecting the at least one portable electronic device to the base portion, the at least one connector having a first pin configuration for communicating with portable electronic devices of a first type
whereby a user can removably secure the at least one portable electronic device to the at least one connector to allow electrical communication between the docking station and the portable electronic device and can connect the at least one portable electronic device to the base portion such that the portable electronic device is centrally located with respect to the base portion.

2. The docking station of claim 1 further comprising a cradle removably attached to the base portion, the cradle having an opening therein wherein the at least one connector is disposed therethrough.

3. The docking station of claim 2, wherein the at least one connector is coupled to a circuit board, the circuit board being disposed between the base portion and the cradle such that the circuit board is slidably engaged with the base portion.

4. The docking station of claim 3, wherein the circuit board is removably secured to the cradle by a screw.

5. The docking station of claim 2, wherein the opening is configured to cause the connector to translate along an axis with respect to the base portion to alter the location of the portable electronic device with respect to the base portion.

6. The docking station of claim 1 further comprising a stationary connector coupled to the base portion, the stationary connector having a second pin configuration for communicating with portable electronic devices of a second type.

7. The docking station of claim 6 further comprising a device recognizer configured to recognize the type of portable electronic device connected to the docking station through the at least one connector and the stationary connector, and provide a signal to the portable electronic device corresponding to the determined type of portable electronic device.

8. The docking station of claim 7, wherein the device recognizer is configured to recognize a plurality of satellite radio enabled portable electronic devices.

9. The docking station of claim 7, wherein the device recognizer is configured to recognize a plurality of music player portable electronic devices.

10. The docking station of claim 7, wherein the device recognizer is configured to recognize a plurality of game console portable electronic devices.

11. The docking station of claim 7, wherein the device recognizer is configured to recognize a plurality of video player portable electronic devices.

12. The docking station of claim 1 further comprising a configurable power supply module capable of providing power to the at least one portable electronic device through the at least one connector, wherein the power supply module is configured responsive to the determined type of portable electronic device.

13. The docking station of claim 1 further comprising an audio amplifier configured to receive an audio signal from the at least one portable electronic device through the at least one connector, wherein the audio amplifier is configured responsive to the determined type of portable electronic device.

14. The docking station of claim 13 further comprising a digital rights management module configured selectively to enable playback of the audio signal depending on availability at the docking station of rights to content represented by the audio signal.

15. The docking station of claim 1 further comprising an audio amplifier configured to receive an audio signal from the at least one portable electronic device through the at least one connector, wherein input impedance of the audio amplifier is configured responsive to the determined type of portable electronic device.

16. The docking station of claim 15 further comprising a digital rights management module configured selectively to enable playback of the one or more video signals depending on the availability at the docking station of rights to content represented by the audio signal.

17. The docking station of claim 1 further comprising a display portion coupled to the base portion, the display portion being substantially perpendicular to the base portion.

18. The docking station of claim 17, wherein the display portion includes a video display and the at least one connector comprises video input for driving the video display with one or more video signals.

19. The docking station of claim 17, wherein the display portion comprises an audio display having at least one speaker.

20. The docking station of claim 1 further comprising circuitry located within the base portion for allowing wireless communication between the docking station and a remote control.

21. The docking station of claim 1 further comprising circuitry located within the base portion for allowing wireless communication between the docking station and one or more external speakers.

22. A docking station comprising:
a) a base portion having circuitry therein for processing signals from at least one portable electronic device connected to the base portion;
b) a display portion coupled to the base portion, the display portion being substantially perpendicular with the base portion;
c) at least one connector slidably engaged with the base portion for connecting the at least one portable electronic device to the base portion, the at least one connector having a first pin configuration for communicating with portable electronic devices of a first type; and
d) a cradle removably attached to the base portion, the cradle having an opening therein wherein the at least one connector is disposed therethrough, the opening configured to cause the connector to translate along an axis with respect to the base portion to alter the location of the portable electronic device with respect to the base portion such that the portable electronic device is centrally located with respect to the display portion
whereby a user can removably secure the at least one portable electronic device to the at least one connector to allow electrical communication between the docking station and the portable electronic device and can connect the at least one portable electronic device to the base portion such that the at least one portable electronic device is centrally located with respect to the display portion.

23. The docking station of claim 22, wherein the at least one connector is coupled to a circuit board, the circuit board being disposed between the base portion and the cradle such that the circuit board is slidably engaged with the base portion.

24. The docking station of claim 22 further comprising a stationary connector coupled to the base portion, the stationary connector having a second pin configuration for communicating with a portable electronic device of a second type.

25. The docking station of claim 22 further comprising a configurable power supply module capable of providing power to the at least one portable electronic device through the at least one connector, wherein the power supply module is configured responsive to the determined type of portable electronic device.

26. The docking station of claim 22 further comprising:
a) an audio amplifier configured to receive an audio signal from the at least one portable electronic device through the at least one connector, wherein the audio amplifier is configured responsive to the determined type of portable electronic device and
b) a digital rights management module configured selectively to enable playback of the audio signal depending on availability at the docking station of rights to content represented by the audio signal.

27. The docking station of claim 26, wherein the display portion comprises an audio display having at least one speaker.

28. The docking station of claim 22 further comprising an audio amplifier configured to receive an audio signal from the at least one portable electronic device through the at least one connector, wherein input impedance of the audio amplifier is configured responsive to the determined type of portable electronic device.

29. The docking station of claim 22, wherein the display portion includes a video display and the at least one connector comprises video input for driving the video display with one or more video signals.

30. The docking station of claim 29, wherein the video display encompasses less than the entire display portion.

31. The docking station of claim 29 further comprising a digital rights management module configured selectively to enable playback of the one or more video signals depending on the availability at the docking station of rights to content represented by the audio signal.

32. A docking station comprising:
a) a base portion having circuitry therein for processing signals from at least one portable electronic device connected to the base portion;
b) a display portion coupled to the base portion, the display portion being substantially perpendicular with the base portion;
c) at least one connector slidably engaged with the base portion for connecting the at least one portable electronic device to the base portion, the at least one connector coupled to a circuit board, the circuit board being disposed between the base portion and the cradle, the at least one connector having a first pin configuration for communicating with portable electronic devices of a first type;
d) a cradle removably attached to the base portion, the cradle having an opening therein wherein the at least one connector is disposed therethrough, the opening configured to cause the at least one connector to translate along an axis with respect to the base portion to alter the location of the portable electronic device with respect to the base portion such that the at least one portable electronic device is centrally located with respect to the projector portion; and
e) a stationary connector coupled to the base portion, the stationary connector having a second pin configuration for communicating with portable electronic devices of a second type
whereby a user can removably secure the at least one portable electronic device to the at least one connector to allow electrical communication between the docking station and the portable electronic device and can connect the at least one portable electronic device to the base portion such that the portable electronic device is centrally located with respect to the display portion.
